(19) United States
(12) Patent Application Publication
(10) Pub. No.: US 2009/0119921 A1
(43) Pub. Date: May 14, 2009

(54) Method for making orifices in the secondary casings of a pressurized water reactor steam generator

(75) Inventors: Olivier Theallier, Saint Pierre De Varennes (FR); Jean-Claude Ferlay, Chatenoy Le Royal (FR)

Correspondence Address: CONNOLLY BOVE LODGE & HUTZ LLP, 1875 EYE STREET, N.W., SUITE 1100, WASHINGTON, DC, 20006, US

(73) Assignees: AREVA NP, Courbevoie (FR); ELECTRICITE DE FRANCE, Paris (FR)

(21) Appl. No.: 12/185,959

(22) Filed: Aug. 5, 2008

(30) Foreign Application Priority Data
Aug. 7, 2007 (FR) 07 56976

(51) Int. Cl. B23P 6/00

(52) U.S. Cl. 29/890.031

(57) ABSTRACT

The method consists in making sure that the steam generator (1) is full of water and topping it up if necessary, using mechanical tooling (15) to pierce a blind pre-orifice (22) into part of the thickness of the pressure boundary (2), lowering the water level in the steam generator (1) to just above the pre-orifice (22), using electrical discharge machining to finish piercing the orifice (9) in the pressure boundary (2), and using electrical discharge machining also to make an orifice (10) in the bundle wrapper (3).

The present invention relates to a method for making orifices in the secondary casings of a pressurized water reactor steam generator.

Steam generators used to produce steam from the heat supplied by the cooling water of a pressurized water reactor comprise an outer casing known as the pressure boundary, of cylindrical overall shape, which is positioned with its axis vertical and encloses internal structures of the steam generator including, in particular, a bundle of tubes for the exchange of heat between the primary fluid which consists of the pressurized cooling water that cools the nuclear reactor and that flows inside the tubes of the bundle, and the feedwater which is brought into contact with the exterior surface of the tubes of the bundle in the secondary part of the steam generator.

The steam generator bundle consists of a great many bent U-shaped heat-exchange tubes each having two straight branches which are fixed at their ends in through-holes in a tube plate secured to the pressure boundary of the steam generator.

When the steam generator is in its service position, the cylindrically shaped pressure boundary is positioned with its axis vertical, the tube plate is horizontal and the straight branches of the tubes of the bundle are vertical. The tube bundle is positioned inside a bundle wrapper, of cylindrical overall shape, which is positioned coaxially inside the pressure boundary.

The bundle wrapper which completely surrounds the bundle is partially closed at its upper part, above the upper part of the bundle which consists of the bent parts of the tubes. The bundle wrapper at its upper part has an opening through which the steam produced in contact with the tubes of the bundle passes. The steam leaving the bundle wrapper passes along inside a collection of separators and dryers which occupies the entire upper part of the pressure boundary, above the bundle wrapper.

The steam generator feedwater is introduced, in the upper part of the bundle wrapper, into an annular space between the bundle wrapper and the pressure boundary.

The feedwater flows in the vertical direction, initially downwards in the annular space between the bundle wrapper and the pressure boundary, as far as the tube plate, to enter the bundle wrapper of which the wall, at its lower part, leaves a space for the passage of water above the tube plate.

The tube plate is pierced with a network of through-holes through which the end parts of the straight branches of the tubes of the bundle pass and in which they are secured, with the exception of a central region extending across a diameter that is free of tube through-holes. Each of the U-shaped bent tubes of the bundle has a first branch engaged and fixed in a hole in a first part of the network of holes situated on one side of the central region and a second branch engaged and fixed in a hole in the second part of the network positioned symmetrically with respect to the position of the first hole.

The straight branches of the tube bundle are held in position by tube support plates distributed along the length of the bundle, inside the bundle wrapper, and comprising networks of holes identical to the network of holes in the tube plate.

In this way, the tube bundle, which has a cylindrical overall shape and which is positioned coaxially with respect to the bundle wrapper and with respect to the pressure boundary, has in its central part a tube-free space, running axially, in vertical alignment with the diametral central region of the tube plate in which there are no tube fixing holes.

The primary part of the steam generator consists of the space inside the tubes of the bundle and of a water box positioned below the tube plate of the steam generator and into which the ends of the tubes of the bundle which are fixed into the holes passing through the tube plate open. The secondary part of the steam generator consists of the internal part of the steam generator outer casing, above the tube plate. The secondary part of the steam generator contains the internal structures which, in particular, include the steam generator bundle, the bundle wrapper, and the steam separators and dryers.

When the steam generator has been in operation for a certain length of time, certain operations need to be performed inside this steam generator, especially inside the secondary part, it being possible for these operations to be inspections, cleaning, repair or extraction of foreign bodies from the tube bundle. These operations are generally carried out as part of the annual maintenance operations performed on steam generators when the nuclear reactor has been shut down, for example in order to refuel the nuclear reactor by refuelling the core with nuclear fuel.

The operations are generally performed at the steam generator tube plate and possibly at the tube support plates.

One of the maintenance operations habitually performed above the tube plate is that of lancing out the sludge that has become deposited on the upper face of the tube plate, on the secondary side of the steam generator. Foreign bodies introduced with the feedwater between the tubes of the bundle can also be extracted when such bodies have been detected using a televisual inspection of the bundle.

In order to carry out the various operations in the secondary part of the steam generator, there are various devices that have been proposed in order to permit access to intervention zones in the secondary part of the steam generator.

In order to carry out a visual inspection inside the secondary part it has, for example, been proposed that use be made of a small vehicle equipped with a camera, a toolholder device, which can be used in the annular region between the bundle wrapper and the pressure boundary and various inspection devices that can be inserted between the tubes of the bundle via the lower part of the bundle wrapper.

To carry out the inspection, to lance sludge from the plates and to extract foreign bodies from the bundle, various devices have also been proposed that can be inserted and moved around above the tube plate, in the empty central space of the bundle.

Some devices also allow inspection or cleaning operations to be performed in a part of the bundle situated above the tube plate, for example above a tube support plate or between any two arbitrary tube support plates.

In general, all the operations performed in the secondary part of the steam generator are performed using movement, inspection or maintenance devices which are introduced into the secondary part of the steam generator via orifices through the pressure boundary and the bundle wrapper, at a point corresponding to the bottom part of the bundle, slightly above the tube plate.

In order to access the upper parts of the steam generator bundle, between the tube support plates, the inspection or operating tools are passed through openings that pass through the tube support plates, either in their central part, or at their periphery, in vertical alignment with the diametral part of the tube plate in which there are no tube through-holes, which is known as the tube lane.

It has also been proposed that examinations be performed inside the bundle using a very small-diameter video camera which is introduced into the bundle wrapper via its upper part, so as to perform a visual inspection of the peripheral part of the upper tube support plate.

An inspection may also be performed at the tube support plates situated below the upper plate, by passing the probe or the camera into the spaces between the tubes and into the water passage holes that pass through the tube support plates. Use of this method is limited because it is necessary to use a very small-diameter probe or camera and because the inspection regions are limited by the presence of anti-vibration bars in the upper part of the bundle and, as a result, inspection can be carried out only in a small proportion of the steam generator bundle.

The known visual inspection or cleaning methods and devices cannot therefore be used to inspect or clean in the upper part of a steam generator bundle unless the steam generator has tube support plates with openings in vertical alignment with the tube lane or the water passage holes. These methods and devices cannot therefore be used in a great many steam generators of different models which do not have these special design features regarding their tube support plates.

In addition, the known inspection or cleaning devices, in order to access the spaces between the tubes, above the various tube support plate distributed over the height of the bundle, take a path which entails three or even four changes in direction and have to be moved, in the vertical direction, towards the upper parts of the steam generator bundle. All of these constraints entail the use of means that are highly complex and extremely tricky to operate in order to move and actuate the intervention means within the steam generator bundle.

It is an object of the invention to propose a method for making orifices in the secondary casings of a pressurized water reactor steam generator that facilitates operations particularly at the tube support plates of this steam generator.

A subject of the invention is therefore a method for making orifices in the secondary casings for a steam generator of a pressurized water reactor, the said secondary casings comprising a bundle wrapper positioned concentrically inside a pressure boundary, characterized in that, following a cold shutting-down of the nuclear reactor, it consists in the following steps:
a) making sure that the steam generator is full of water and topping it up if necessary,
b) using mechanical tooling to pierce a blind preorifice into part of the thickness of the pressure boundary,
c) lowering the water level in the steam generator to just above the pre-orifice,
d) using electrical discharge machining to finish piercing the orifice in the pressure boundary, and
e) using electrical discharge machining also to make an orifice in the bundle wrapper, the orifices in the pressure boundary and the bundle wrapper respectively being more or less coaxial and of the same axis and more or less of the same diameter.

According to other features of the invention:
prior to step b), a centring pilot hole is made through part of the thickness of the pressure boundary and along the axis of the orifice that is to be made in this pressure boundary;
from the centring pilot hole, holes are made around this orifice, these holes being for attaching the mechanical-piercing tooling, on the one hand, and a cover for blanking off the orifice in the pressure boundary, on the other hand;
prior to step b), the thickness of the pressure boundary is measured and the mechanical-piercing tooling is programmed with the depth of the preorifice;
prior to step c), a vertical flat surface is made on the exterior wall of the pressure boundary in order to fit a gasket for sealing a cover that blanks off the orifice of the pressure boundary;
between steps b) and c), the pre-orifice is bored and a flat bottom is produced in this pre-orifice;
after step d), a fillet is produced on the internal edge of the orifice in the pressure boundary so as to eliminate stress concentrations, and
the fillet on the internal edge of the orifice in the pressure boundary is produced by electrical discharge machining.

The features and advantages of the invention will become apparent through the description which will follow, given by way of example and made with reference to the attached drawings in which:

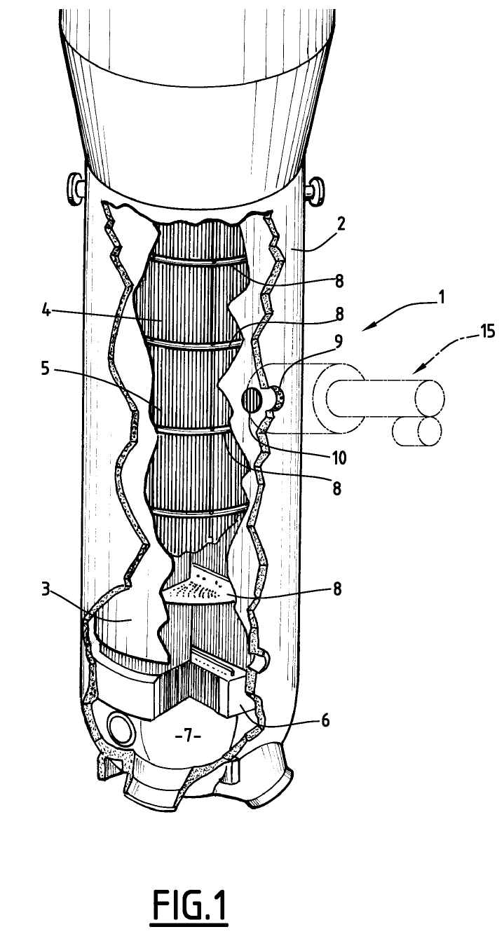

FIG. 1 is a schematic perspective view of a pressurized water reactor steam generator;

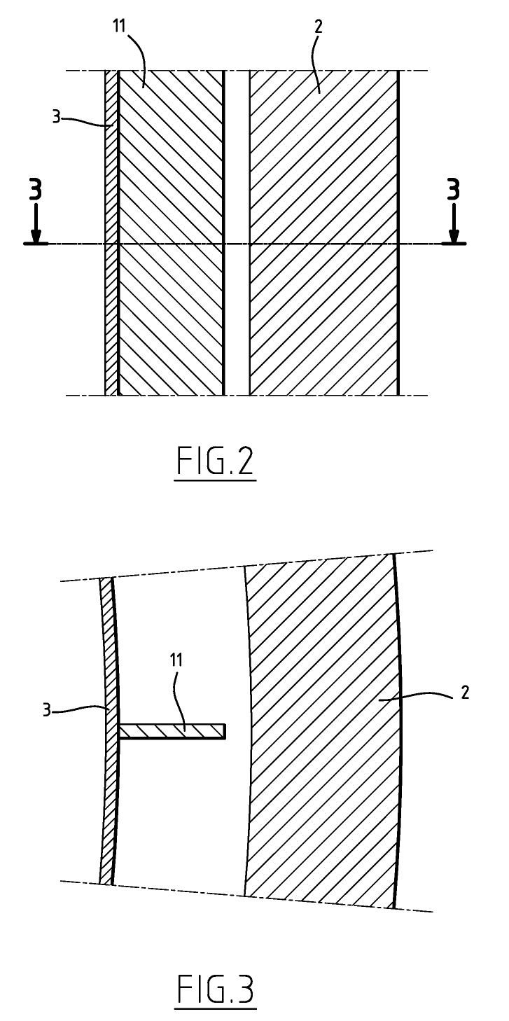

FIG. 2 is a schematic view in vertical section of a portion of the casings of the steam generator in the region where the orifices are to be made using the method according to the invention;

FIG. 3 is a view in cross section on 3-3 of FIG. 2;

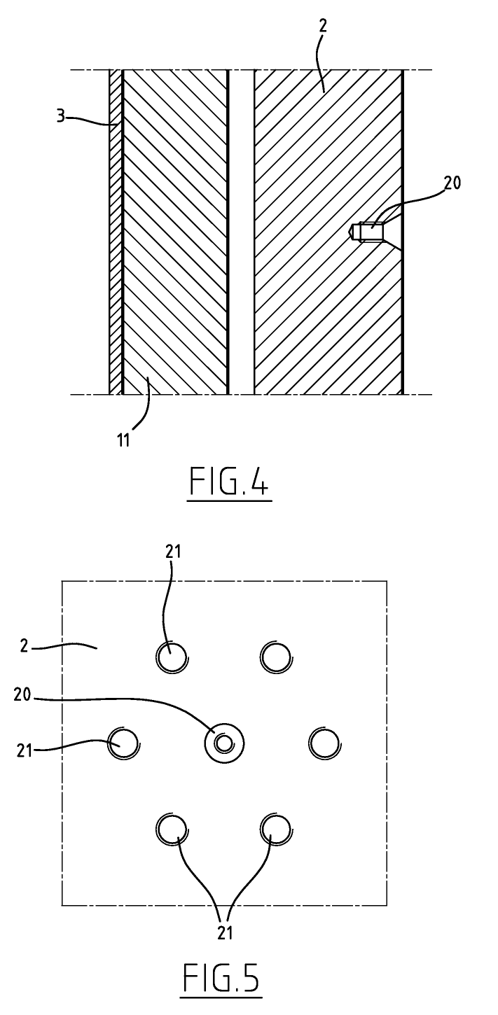

FIGS. 4 to 12 are schematic views showing the various steps in implementing the method;

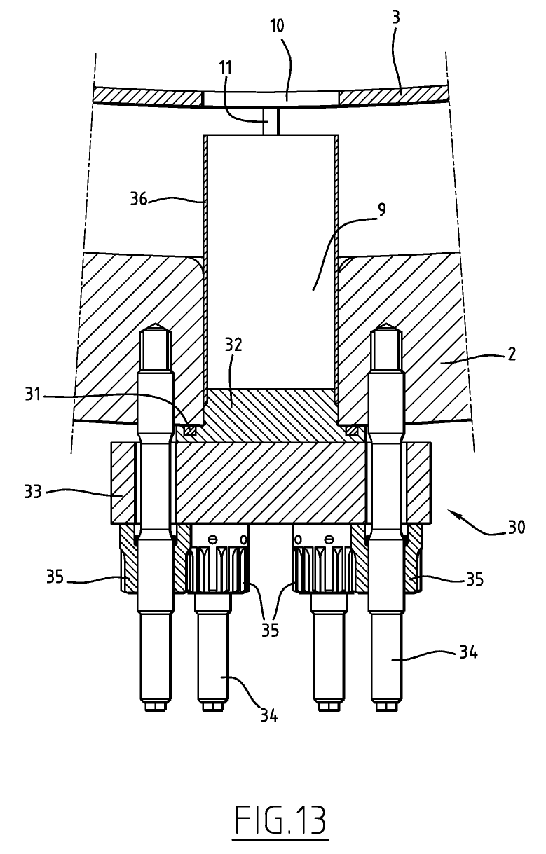

FIG. 13 is a schematic view in cross section of a cover for blanking off the orifice in the pressure boundary; and

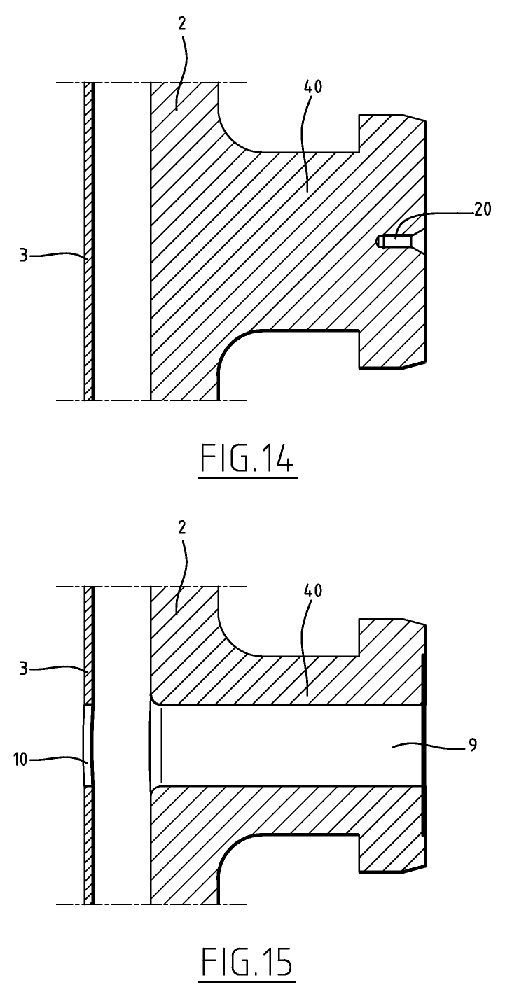

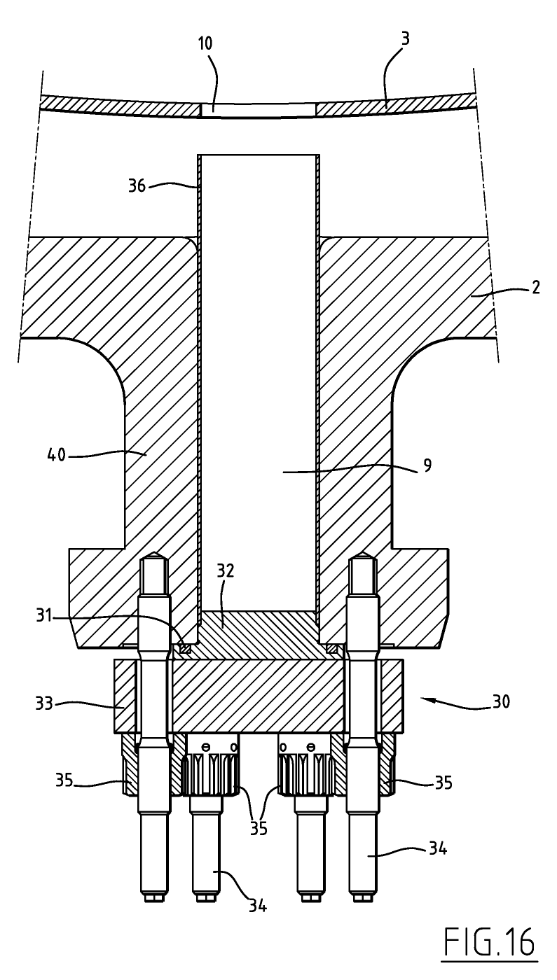

FIGS. 14 to 16 are schematic views in cross section of another portion of the casings of the steam generator in the region where the orifices are made using the method according to the invention.

FIG. 1 depicts the lower part of a pressurized water reactor steam generator denoted by the general reference 1.

The steam generator 1 comprises, in the convention way, a pressure boundary 2 of substantially cylindrical shape, inside which there is positioned, coaxially, a bundle wrapper 3 containing a tube bundle 4 of the steam generator 1.

Tube bundle 4 consists of a great many tubes 5 bent into a U, each comprising two straight branches which are engaged and fixed at their ends in a tube plate 6 fixed to the lower part of the pressure boundary 2 of the steam generator 1. The pressure boundary 2 is connected to a hemispherical end delimiting a water box 7 in two parts.

Fixed inside the bundle wrapper 3, in successive positions along the height of the bundle, are tube support plates 8 intended to hold the branches of the tubes 5 of the bundle 4 in position to prevent them from vibrating while the steam generator is in operation. Each of the tube support plates 8 is pierced with a network of openings similar to the network of openings that pass through the tube plate 6 into which the ends of the tubes 5 of the bundle 4 are fixed. The straight branches of the tubes 5 of the bundle are engaged in aligned openings in the tube support plates 8 spaced along the longitudinal direction of the tube 5.

In the conventional way, feedwater for the steam generator 1 is introduced into the pressure boundary 2 so that it can flow downwards inside the bundle wrapper 3 in contact with the exterior surface of the tubes 5. The feedwater flowing in contact with the tubes becomes heated and is then turned into steam. The steam produced is collected in the upper part of the steam generator to be sent to the nuclear reactor turbine.

The feedwater collected in the turbine condenser is returned to the steam generator and the feedwater is circulated via the secondary circuit of the nuclear reactor.

The water circulating through the secondary circuit and inside the secondary part of the steam generator, in contact with the exterior surface of the tubes 5 of the bundle 4, becomes laden with impurities such as oxides which may be deposited in the form of sludge on the upper surface of the tube plate 6 and also on the tube support plates 8, particularly in the gaps between the tubes 5 and the openings in these tube support plates 8 which have to hold the tubes 5 in position and allow the feedwater in contact with the exterior surface of the said tubes 5 to pass.

When the nuclear reactor is shut down when the steam generator 1 has been in operation for a certain length of time, it is necessary to perform certain operations inside the steam generator and, in particular, at the tube support plates 8. These operations may be inspections, cleaning operations using a sludge-cleaning lance, repairs or the extraction of foreign bodies from the tube bundle 4 of the steam generator.

To do that, as shown in FIG. 1, the method according to the invention is used to pierce an orifice 9 in the pressure boundary 2 and an orifice 10 in the bundle wrapper 3 near the tube support plate 8 at which the operation is to be performed.

In what follows, the orifice 9 will be termed the external orifice 9 and the orifice 10 will be termed the internal orifice 10. These orifices, the external orifice 9 and the internal orifice 10, respectively, are also denoted in the common way by the expression “inspection holes”.

The internal orifice 10 is positioned along the axis of the external orifice 9 and has a diameter more or less equal to this external orifice 9.

The various steps in the method of making the orifices 9 and 10 in the pressure boundary 2 and the bundle wrapper 3, respectively, will now be described with reference to FIGS. 2 to 13. These figures depict a portion of the casings 2 and 3 in the region where the orifices 9 and 10 are to be made. In this portion, the bundle wrapper 3 may have a vertical flat 11, the purpose of which is to distribute the flow of water between the pressure boundary 2 and the bundle wrapper 3.

By way of example, the thickness of the pressure boundary 2 ranges between 111 and 114 mm, the thickness of the bundle wrapper 3 is 10 mm and the width of the web 11 is 80 mm.

Prior to performing the various operations of piercing the casings 9 and 10, the nuclear reactor is shut down and the operators wait until the temperature of this steam generator has dropped to 30 to 40° C.

Next, it is ensured that the steam generator 1 is full of water and topped up if necessary, in order to reduce the dosimetry to which the operators are exposed.

Next, the various steps for making the external orifice 9 in the pressure boundary 2, followed by the internal orifice 10 in the bundle wrapper 3 can begin, these steps being described with reference to FIGS. 4 to 12.

First of all, appropriate tooling of the known type is used to produce a centring pilot hole 20 (FIG. 4) through part of the thickness of the pressure boundary 2 and along the axis of the orifice 9 that is to be made in this pressure boundary 2. From this centring pilot hole 20, holes 21 (FIG. 5) are produced around this pilot hole 20 for attaching mechanical-piercing tooling and a blanking-off cover, as will be seen later on. These fixing holes 21 are, for example, six in number distributed uniformly around the centring pilot hole 20.

Mechanical-piercing tooling 15 depicted schematically in dotted line in FIG. 1 is mounted on the exterior wall of the pressure boundary 2 and using the fixing holes 21. This tooling 15 is of a known type and for example consists of a drill which, in the conventional way, comprises a hydraulic motor for driving a tool-holding spindle and an electric motor providing the advance movement, equipped with an encoder.

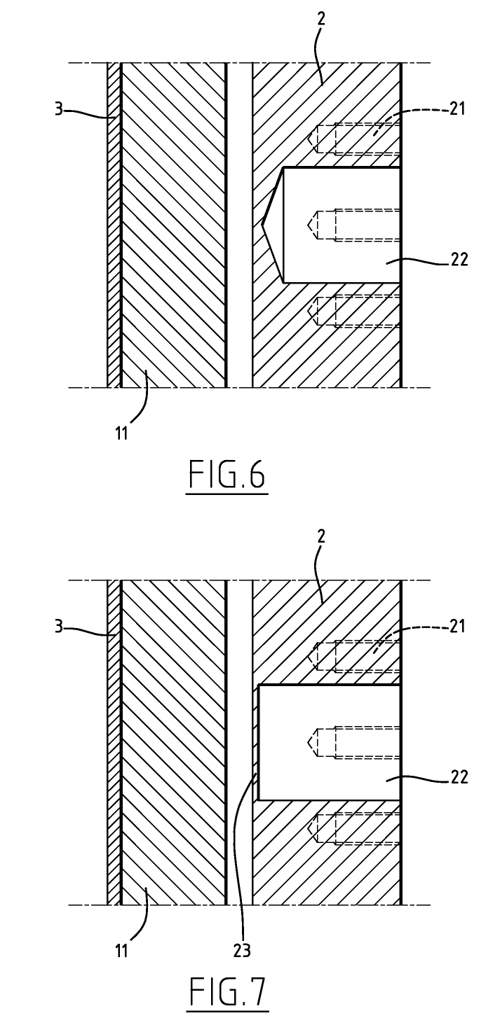

Prior to piercing the pressure boundary 2, the thickness of this pressure boundary 2 is measured so as to programme the electric motor of the tooling 15 in order to make a blind pre-orifice 22 (FIG. 6) through part of the thickness of the pressure boundary 2. The diameter of this pre-orifice 22 is, for example, 90 mm and the thickness of the remaining web of the pressure boundary 2 at the site of this pre-orifice 22 is between 1/10^{th} of a mm and 10 mm and preferably between 2 and 5 mm.

The fact that the pre-orifice 22 does not open into the steam generator 1 makes it possible to prevent any chips produced by the mechanical-piercing tooling from dropping into the steam generator 1 and being carried by the water into the secondary circuit of the nuclear reactor with the serious consequences that that would have.

In addition, the presence of water inside the steam generator makes it possible to prevent operators performing the various operations from being subjected to high levels of radiation.

In order to prepare for the next step of the making of the external orifice 9 in the pressure boundary 2, a flat bottom 23 is made in this pre-orifice 22 by means of a flat-bottomed tool of a known type, as depicted in FIG. 7. This tool also bores out the pre-orifice 22.

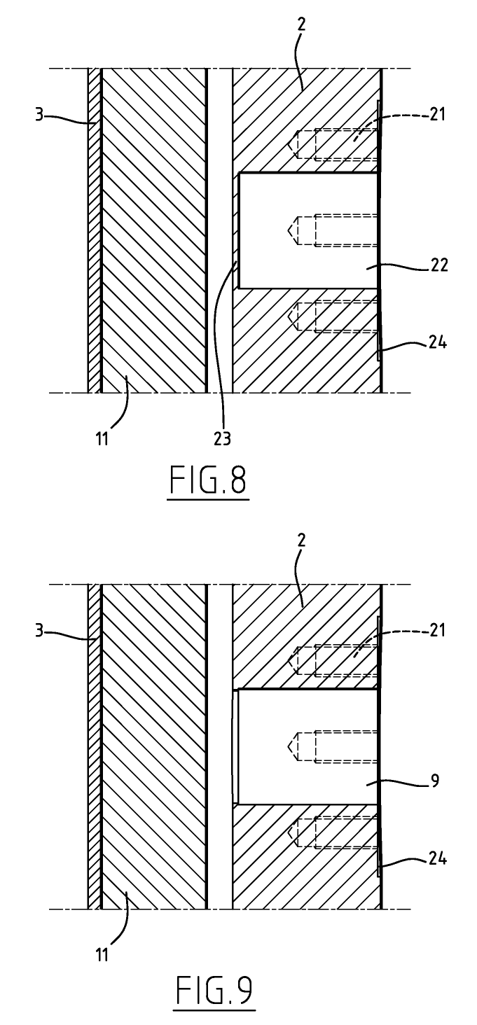

The next step depicted in FIG. 8 is to produce a vertical flat reference surface 24 around the pre-orifice 22 on the external wall of the pressure boundary 2 in order to fit a gasket to seal the cover used to blank off the external orifice 9, as will be seen later.

Next, the water level in the steam generator 1 is reduced to just above the pre-orifice 22 made in the pressure boundary 2. Electrical discharge machining of a known type, for piercing holes, the electrode of which is intended to pierce right through the pre-orifice 22 in order to obtain the external orifice 9 as shown in FIG. 9, is mounted on the external wall of the pressure boundary 2. Piercing the hole using electrical discharge machining avoids the formation of chips. When the orifice 9 has been pierced right through the pressure boundary 2, the excess water contained in the steam generator 1 flows out through this orifice 9 into a tray, not depicted, which collects the demineralized water used for electrical discharge machining to pierce the hole. The electrical discharge machine tooling used to pierce the hole is of a known type and, in this instance, has a central electrode.

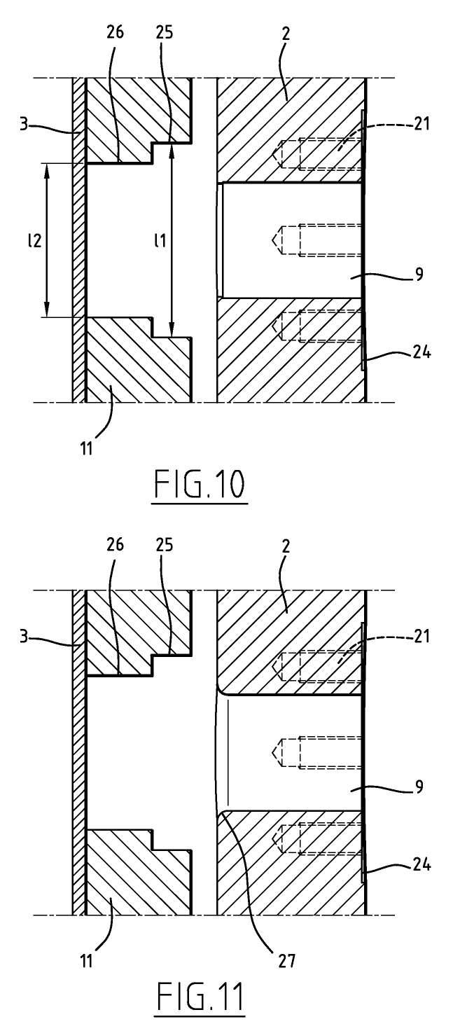

Still using this electrical discharge machine tooling used for the piercing, but with an offset electrode, a first opening 25 of width 11 is made in the flat 11, along the axis of the external orifice 9, followed by a second opening 26 of width 12 in the flat 11, the width 11 of the first opening 25 being greater than the width 12 of the second opening 26. By way of example, the width 11 of the first opening 25 is of the order of 150 mm, and the width 12 of the second opening 26 is of the order of 120 mm (FIG. 10).

As shown in FIG. 11, a fillet 27 is produced on the internal edge of the external orifice 9 using the electrical discharge machine tooling with the offset electrode. This fillet 27 makes it possible to eliminate stress concentrations.

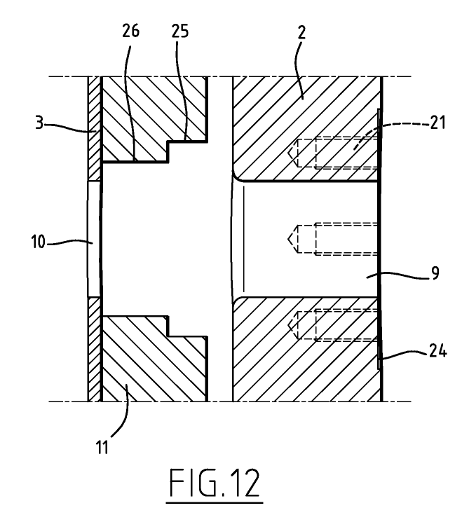

Next, still using the electrical discharge machine tooling with the offset electrode, the bundle wrapper 3 is pierced in such a way as to obtain the internal orifice 10. This internal orifice 10 has a diameter of the order of 90 mm identical to the diameter of the external orifice 9 and these orifices, the external one 9 and the internal one 10, respectively, are more or less coaxial (FIG. 12).

Once the various operations have been performed inside the bundle wrapper 3, particularly in the region of the tube support plate 8 situated below the internal orifice 10, such as inspections, cleaning, repair or the extraction of foreign bodies from the tube bundle 4, have been carried out, the external orifice 9 is closed using a cover denoted overall by the reference 30 and depicted in FIG. 13.

This cover 30 comprises a gasket 31, for example made of graphite, held against the flat surface 24 of the exterior wall of the pressure boundary 2 by means of a packing ring 32. This packing ring 32 is pressed against the external wall of the pressure boundary 2 by a plug 33 held against this external wall by studs 34 and nuts 35.

The studs 34 are screwed into the fixing holes 21 and are tensioned on account of the pressure obtaining inside the steam generator 1 when the steam generator is in operation.

A sleeve 36 which opens into the space formed between the pressure boundary 2 and the bundle wrapper 3 as, shown in FIG. 13, is positioned inside the external orifice 9. This sleeve 36 makes it possible to re-establish water circulation in this region as a result of the openings made in the flat 11. The cover 30 is able to withstand the pressure obtaining inside the steam generator 1 when the latter is in operation, which pressure generally ranges between 70 and 80 bar.

According to an alternative form depicted in FIGS. 14 to 16 and depending on the location on the steam generator 1 at which the operation or operations is or are to be performed, the external orifice 9 may be pierced in a trunnion 40 to which means for lifting or supporting the steam generator 1 are attached. In this case, the procedure is identical, making a centring pilot hole 20, fixing holes 21, a pre-orifice 22 and the external orifice 9.

After the various operations have been performed inside the bundle wrapper 3, a cover 30 is also positioned over the external orifice 9, in the region of the trunnion 40.

The method according to the invention therefore makes it possible to produce orifices for the passage of operating means into the steam generator in any region of the steam generator. The operations of positioning the operating means in the steam generator are made easier and these operations do not require the use of any complicated device for moving the operating means around.

The method according to the invention applies to any steam generator comprising a pressure boundary and a bundle wrapper in which the steam generator tube bundle is held in position by tube support plates.

1. Method for making orifices in the secondary casings for a steam generator of a pressurized water reactor, the said secondary casings comprising a bundle wrapper positioned concentrically inside a pressure boundary, wherein, following a cold shutting-down of the nuclear reactor, it consists in the following steps:
a) making sure that the steam generator is full of water and topping it up if necessary,
b) using mechanical tooling to pierce a blind preorifice into part of the thickness of the pressure boundary,
c) lowering the water level in the steam generator to just above the pre-orifice,
d) using electrical discharge machining to finish piercing the orifice (9) in the pressure boundary, and
e) using electrical discharge machining also to make an orifice in the bundle wrapper, the orifices in the pressure boundary and the bundle wrapper respectively being more or less coaxial and of the same diameter.

2. Method according to claim 1, wherein, prior to step b), a centring pilot hole is made through part of the thickness of the pressure boundary and along the axis of the orifice that is to be made in this pressure boundary.

3. Method according to claim 2, wherein, from the centring pilot hole, holes are made around this orifice, these holes being for attaching the mechanical-piercing tooling, on the one hand, and a cover for blanking off the orifice in the pressure boundary, on the other hand.

4. Method according to claim 1, wherein, prior to step b), the thickness of the pressure boundary is measured and the mechanical-piercing tooling is programmed with the depth of the pre-orifice.

5. Method according to claim 1, wherein, prior to step c), a vertical flat surface is made on the exterior wall of the pressure boundary in order to fit a gasket for sealing a cover that blanks off the orifice.

6. Method according to claim 1, wherein, between steps b) and c), the pre-orifice is bored and a flat bottom is produced in this pre-orifice.

7. Method according to claim 1, wherein, after step d), a fillet is produced on the internal edge of the orifice in the pressure boundary so as to eliminate stress concentrations.

8. Method according to claim 7, wherein the fillet on the internal edge of the orifice in the pressure boundary is produced by electrical discharge machining.
